(19) United States
(12) Patent Application Publication
(10) Pub. No.: US 2018/0222314 A1
(43) Pub. Date: Aug. 9, 2018

(54) COMPONENT FOR FUEL FEED APPARATUS

(71) Applicant: TOYODA GOSEI CO., LTD., Kiyosu-shi (JP)

(72) Inventors: Kiyofumi SAKAI, Kiyosu-shi (JP); Osamu MABUCHI, Kiyosu-shi (JP); Shuji KUBOTA, Otsu-shi (JP); Nobuhiro YOSHIMURA, Otsu-shi (JP); Yuhei FUKUMOTO, Otsu-shi (JP); Kazuki IWAMURA, Otsu-shi (JP)

(21) Appl. No.: 15/889,398

(22) Filed: Feb. 6, 2018

(30) Foreign Application Priority Data
Feb. 7, 2017 (JP) 2017-020064

(51) Int. Cl. B60K 15/04; C08L 77/00; C08L 23/08; C08K 3/04; C09J 123/06

(52) U.S. Cl. CPC B60K 15/04; C08L 77/00; C08L 23/0815; B60K 2015/03401; C09J 123/06; C08L 2207/062; C08K 2201/001; C08K 3/04

(57) ABSTRACT

Provided is a component used in a fuel feed apparatus (500), containing: a conductive polyamide layer (25) formed of a conductive polyamide resin composition, in which the conductive polyamide resin composition contains: a polyamide resin, a conductive carbon black, an ethylene-α-olefin copolymer, and a conductive polyethylene resin, and satisfies the following characteristics (a) and (b): (a) initial volume resistivity of a flat plate obtained by injection forming is 1×10⁵ Ω·cm or less, and volume resistivity after exposing the flat plate to CM15 fuel for 168 hours is 1×10⁷ Ω·cm or less, and (b) charpy impact strength at −40° C. of a test piece obtained by injection forming is 2.0 KJ/m² or greater.

### TECHNICAL FIELD

The present invention relates to a component used in a fuel feed apparatus that feeds fuel to a fuel tank.

### BACKGROUND ART

There is a case where a polyamide resin is used as a material of a component used in a fuel feed apparatus that feeds fuel to a fuel tank. The polyamide resin shows excellent chemical resistance with respect to an organic solvent such as gasoline, or to an alkaline solution, and has high fluidity, excellent heat resistance, and excellent creep resistance. In addition, there is also a case where carbon black or the like is blended into the polyamide resin to impart conductivity, to thereby suppress generation of static electricity and electric charging, resulting in achieving a function capable of discharging electricity within a relatively short period of time.

As a blending amount of the carbon black increases to improve conductivity, various defects to be solved occur in formability, fluidity, physical properties, and the like of a composition. Here, countermeasures with respect to each of the defects have been proposed. For example, a method where carbon black and a modified ethylene copolymer are blended into a polyamide resin for improving fluidity or formability, is proposed (Patent Document 1); a method where a dispersant of carbon black is blended into a polyamide resin is proposed as a method for achieving both of conductivity and impact resistance (Patent Document 2); and further, a method where conductivity, impact resistance and excellent sliding properties are realized by specifying a morphology structure of a composition is proposed (Patent Document 3).

Patent Document 1: JP-A-S58-93756

Patent Document 2: JP-A-H11-180171

Patent Document 3: JP-A-2006-257429

### SUMMARY OF THE INVENTION

According to each of the proposed methods, improvement effects are respectively recognized. However, the present inventors have found that, in the case of a resin composition having excellent impact resistance, there is a disadvantage that conductivity may deteriorate under the environment of being in contact with fuel, particularly, under the environment of being in contact with alcohol-containing fuel. Therefore, as a component for a fuel feed apparatus in which a conductive polyamide resin composition obtained by blending carbon black into a polyamide resin is used, a component which can form a formed article that is excellent not only in conductivity but also in fuel resisting properties, particularly, excellent fuel resisting properties with respect to the alcohol-containing fuel, and further has high fluidity, excellent formability, and excellent impact resistance, is desirable.

As a result of the intensive research to solve the above-described problem, the present inventors have found that one of the main causes of the problem is that an ethylene-α-olefin copolymer blended for imparting impact resistance or for dispersing conductive carbon black is swollen with fuel, particularly, fuel containing alcohol, and thus a distance between carbon particles of conductive carbon black widens until conductive loss is generated, and that another is oil absorbing properties of the conductive carbon black. Here, the present inventors have further found that the above-described problem can be solved by using a conductive polyamide resin composition of which a morphology structure is controlled by blending a conductive polyamide resin, and have completed the invention.

The present invention has been made in consideration of solving at least a part of the above-described problem, and can be realized by the following aspects.

(1) One aspect of the present invention provides a component used in a fuel feed apparatus that feeds fuel to a fuel tank.

The component contains:

a conductive polyamide layer that is configured to be in contact with fuel or fuel vapor in a use state, and is formed of a conductive polyamide resin composition,

in which the conductive polyamide resin composition contains:
(A) 84 to 40% by weight of a polyamide resin,
(B) 5 to 30% by weight of a conductive carbon black,
(C) 3 to 30% by weight of an ethylene-α-olefin copolymer having a reactive functional group capable of reacting with a terminal group and/or an amide group in a main chain of the polyamide resin, and
(D) 1 to 20% by weight of a conductive polyethylene resin, and

in which the conductive polyamide resin composition satisfies the following characteristics (a) and (b):
(a) initial volume resistivity of a flat plate (100 mm×100 mm×2 mm (thickness)) obtained by injection forming the conductive polyamide resin composition is 1×10⁵ Ω·cm or less, and volume resistivity after exposing the flat plate to CM15 fuel for 168 hours is 1×10⁷ Ω·cm or less, and
(b) charpy impact strength at −40° C. of a test piece obtained by injection forming the conductive polyamide resin composition is 2.0 KJ/m² or greater.

According to the component used in a fuel feed apparatus of this aspect, since a predetermined amount of the ethylene-α-olefin copolymer (C) having a reactive functional group that can react with a terminal group and/or an amide group in a main chain of the polyamide resin is contained, the conductive polyamide resin composition that forms the conductive polyamide layer can impart impact resistance and realize dispersion of the conductive carbon black (B). Further, since a predetermined amount of the conductive polyethylene resin (D) is contained, the conductive polyethylene resin (D) can uniformly disperse while containing conductive carbon black (B_{D}). Therefore, the conductive carbon black (B_{D}) in the conductive polyethylene resin (D) can be close to the conductive carbon black (B) in the polyamide resin, and can contribute to achieving conductivity of the composition. In addition, since oil absorbing properties of the conductive carbon blacks are unlikely to be developed due to polyethylene which is unlikely to be swollen by fuel or alcohol-containing fuel, it is possible to suppress deterioration of conductivity caused by the fuel or the alcohol-containing fuel. Further, since the polyamide resin (A), the conductive carbon black (B), and the ethylene-α-olefin copolymer (C) having a reactive functional group that can react with the terminal group and/or the amide group in the main chain of the polyamide resin are contained, fluidity and formability can be improved. In addition, in a microstructure in the conductive polyamide resin composition contained in the component for a fuel feed apparatus, the morphology structure in which the polyamide resin is to be a continuous phase can be stabilized.

(2) In the component used in a fuel feed apparatus according to the above-mentioned aspect, the conductive polyamide resin composition may further satisfy the following characteristic (c):
(c) a melt index measured at a temperature of 250° C. and at a load of 10 kgf is 2 g/10 min or greater.

According to the component used in a fuel feed apparatus of this aspect, it is possible to improve fluidity of the conductive polyamide resin composition, and to improve formability of the component for a fuel feed apparatus (conductive polyamide layer).

(3) In the component used in a fuel feed apparatus according to the above-mentioned aspects, the conductive polyethylene resin (D) may contain a high-density polyethylene.

According to the component used in a fuel feed apparatus of this aspect, it is possible to improve fuel resisting properties and sliding properties.

(4) The component used in a fuel feed apparatus according to the above-mentioned aspects, may further contain an adhesive polyethylene layer that is configured to be in contact with an outer surface of the conductive polyamide layer.

According to the component used in a fuel feed apparatus of the aspect, since the adhesive polyethylene layer which is in contact with the outer surface of the conductive polyamide layer is provided, it is possible to improve adhesiveness of both layers, and to form at least a part of the component for a fuel feed apparatus as a plurality of layers.

(5) The component used in a fuel feed apparatus according to the above-mentioned aspects, may form at least a part of a fuel flow path which guides the fuel fed from an oil feed gun to the fuel tank.

According to the component used in a fuel feed apparatus of the aspect, since the component has fuel resisting properties, particularly, excellent fuel resisting properties with respect to the alcohol-containing fuel, it is possible to suppress deterioration of a fuel flow path over time even when it is exposed to the fuel. In addition, since deterioration of conductivity is suppressed, the component used in a fuel feed apparatus can be utilized as a part of the conductive path (earth path) from an oil feed gun to a grounded part by, for example, disposing the component to be in contact with the oil feed gun.

(6) In the component used in a fuel feed apparatus according to the above-mentioned aspects, the fuel feed apparatus may contain:
an opening forming member that forms an opening into which the oil feed gun is inserted,
a first valve device that opens and closes the opening,
a second valve device that is positioned further on the fuel tank side than the first valve device, and is opened by insertion of the oil feed gun and closed by extraction of the oil feed gun, and
a hollow filler neck that forms a part of the fuel flow path, is connected to the opening forming member on the fuel tank side, and accommodates the second valve device on an inner side thereof, and

the component may be configured as the filler neck.

According to the component used in a fuel feed apparatus of this aspect, it is possible to provide a filler neck which can form a formed article that has both excellent conductivity and fuel resisting properties, particularly, excellent fuel resisting properties with respect to alcohol-containing fuel, and further has high fluidity, excellent formability, and excellent impact resistance.

The present invention can also be realized in various modes other than the component used in a fuel feed apparatus. For example, it is possible to realize the present invention in modes of a fuel feed apparatus, a producing method of the component used in a fuel feed apparatus, a manufacturing method of the fuel feed apparatus, a vehicle including the fuel feed apparatus, or the like.

According to the present invention, since a predetermined amount of the ethylene-α-olefin copolymer (C) having a reactive functional group that can react with a terminal group and/or an amide group in a main chain of the polyamide resin is contained, the conductive polyamide resin composition that forms the conductive polyamide layer can impart impact resistance and realize dispersion of the conductive carbon black (B). In addition, since a predetermined amount of the conductive polyethylene resin (D) is contained, the conductive polyethylene resin (D) can uniformly disperse while containing conductive carbon black (B_{D}). Therefore, the conductive carbon black (B_{D}) in the conductive polyethylene resin (D) can be close to the conductive carbon black (B) in the polyamide resin, and can contribute to achieving conductivity of the composition. In addition, since oil absorbing properties of the conductive carbon blacks are unlikely to be developed due to polyethylene which is unlikely to be swollen by fuel or alcohol-containing fuel, it is possible to suppress deterioration of conductivity caused by the fuel or the alcohol-containing fuel. Further, since the polyamide resin (A), the conductive carbon black (B), and the ethylene-α-olefin copolymer (C) having a reactive functional group that can react with the terminal group and/or the amide group in the main chain of the polyamide resin are contained, fluidity and formability can be improved. In addition, in a microstructure in the conductive polyamide resin composition in the component for a fuel feed apparatus, the morphology structure in which the polyamide resin is to be a continuous phase can be stabilized.

### BRIEF DESCRIPTION OF DRAWINGS

FIG. 1 is a schematic view illustrating a fuel feed apparatus in which a filler neck that is a component for a fuel feed apparatus according to one embodiment of the present invention is employed.

FIG. 2 is a sectional view illustrating a specific configuration of an opening forming portion.

FIG. 3 is an exploded sectional view illustrating a specific configuration of an opening forming portion.

FIG. 4 is a sectional view illustrating a configuration of a fuel tank tube connection device and a check valve.

FIG. 5 is a sectional view illustrating an appearance of the filler neck when feeding fuel.

FIG. 6 is a sectional view illustrating a specific configuration of a filler neck which is a component for a fuel feed apparatus of a second embodiment of the present invention.

FIG. 7 is a sectional view illustrating a fuel tank tube connection device of the second embodiment.

FIG. 8 is a sectional view illustrating a specific configuration of a filler neck according to a first modification example of the second embodiment.

FIG. 9 is a sectional view illustrating a specific configuration of a filler neck according to a second modification example of the second embodiment.

### MODE FOR CARRYING OUT THE INVENTION

### A. First Embodiment

### A1. Apparatus Configuration:

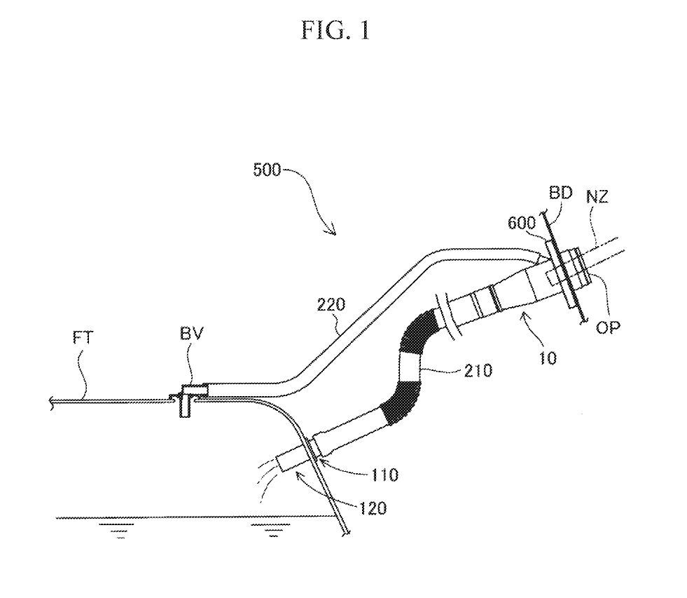

FIG. 1 is a schematic view illustrating a fuel feed apparatus 500 in which a filler neck that is a component for a fuel feed apparatus according to one embodiment of the present invention is employed. The fuel feed apparatus 500 is loaded on a vehicle, which is not illustrated, together with a fuel tank FT. The fuel feed apparatus 500 is attached to the fuel tank FT and a vehicle main body BD, and send fuel fed from a nozzle NZ of an oil feed gun to the fuel tank FT. The attachment of the fuel feed apparatus 500 to the vehicle main body BD is realized by a fixing member 600. The fixing member 600 is a clamp member, and attaches a filler neck (filler neck 20), which will be described later, in the fuel feed apparatus 500 to the vehicle main body BD while nipping and supporting the filler neck. Here, the fuel feed apparatus 500 and the fuel tank FT may be used as being fixed and installed to a building without being loaded on a vehicle.

The fuel feed apparatus 500 includes an opening forming portion 10, a fuel pipe 210, a fuel tank tube connection device 110, a check valve 120, and a fuel vapor pipe 220.

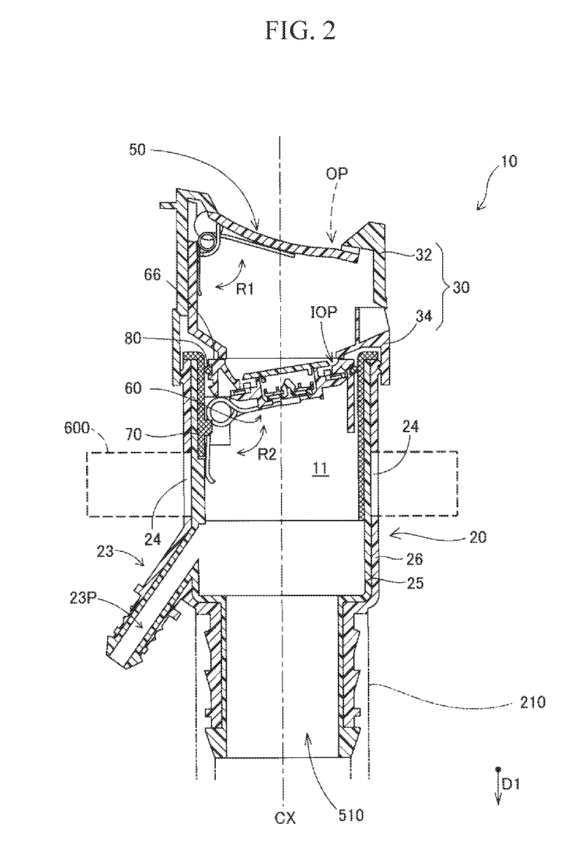

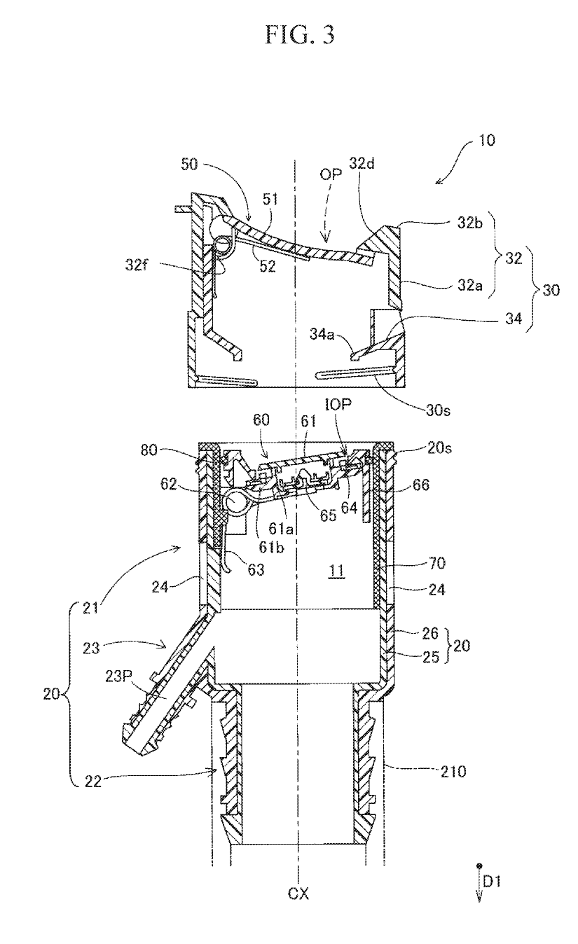

FIG. 2 is a sectional view illustrating a specific configuration of the opening forming portion 10. FIG. 3 is an exploded sectional view illustrating a specific configuration of the opening forming portion 10. The opening forming portion 10 forms an opening OP into which the nozzle NZ is inserted, and forms a part of a fuel flow path 510 which guides the fuel fed from the oil feed gun (nozzle NZ) to the fuel tank FT.

As illustrated in FIG. 2, the opening forming portion 10 includes a first opening forming member 30, a first valve device 50, the filler neck 20, a bracket 70, a second opening forming member 66, and a second valve device 60. Both the first opening forming member 30 and the filler neck 20 have a substantially hollow pipe external appearance shape, and they are connected to each other so that axial lines thereof are substantially identical to each other. In other words, an axial line CX of the opening forming portion 10 is identical to the axial line of the first opening forming member 30 and the axial line of the filler neck 20. The first valve device 50, the second valve device 60, and the bracket 70 are disposed in a hollow portion on an inner side of the first opening forming member 30 and the filler neck 20. In the opening forming portion 10, a direction D1 toward the filler neck 20 from the first opening forming member 30 along the axial line CX is substantially identical to a feeding direction of the fuel. In the present embodiment, the direction D1 is also called a feeding direction D1. In addition, a front side (tip end side) along the feeding direction D1 is called a downstream side, and a rear side (base end side) is also called an upstream side.

The first opening forming member 30 forms the opening OP and accommodates the first valve device 50 in the hollow portion on the inner side thereof. The first opening forming member 30 is also called a so-called “capless structure”, and can open and close the opening OP without using a fuel cap. The first opening forming member 30 includes a cover member 32 and an opening side wall member 34. The cover member 32 is a tubular member that forms the opening OP. As illustrated in FIG. 3, the cover member 32 includes a cylindrical side wall portion 32a disposed on the upstream side of the opening side wall member 34, and an upper wall 32b disposed on the upstream side of the side wall portion 32a. An upper portion of the side wall portion 32a is inclined, and on the inclined upper portion is integrally formed the upper wall 32b. The upper wall 32b includes an opening portion 32d for forming the opening OP. On an inner wall of the side wall portion 32a, a shaft support portion 32f is formed. The shaft support portion 32f mounts and supports an end portion of the first valve device 50. The opening side wall member 34 is a tubular member disposed on the inner side of the cover member 32. The opening side wall member 34 divides the hollow portion on the inner side of the first opening forming member 30, and guides the nozzle NZ inserted from the opening OP in the feeding direction D1. The opening side wall member 34 is provided with an inclined wall 34a. The inclined wall 34a has a conical external appearance shape of which the diameter decreases along the feeding direction D1. In the inner end portion on the downstream side of the first opening forming member 30, a screw thread is formed.

As illustrated in FIG. 3, the first valve device 50 includes a valve body 51 and a spring 52, and opens and closes the opening OP. Specifically, in a usual state where the nozzle NZ is not inserted, the valve body 51 is disposed to block the opening OP by a biasing force of the spring 52. The valve body 51 is rotatable in a direction R1 illustrated in FIG. 2 around the end portion of the valve body 51 supported by the shaft support portion 32f. When the nozzle NZ is inserted, the valve body 51 rotates to the downstream side.

The filler neck 20 has a tubular external appearance shape, and forms an inner flow path 11 which is a part of the fuel flow path 510. In addition, the filler neck 20 accommodates the bracket 70, the second opening forming member 66, and the second valve device 60 in the end portion on the upstream side. The filler neck 20 includes a neck main body 21, a fuel vapor port 23, and a neck connection portion 22, in this order along the feeding direction D1.

The neck main body 21 has a tubular external appearance shape of which a section perpendicular to the axial line CX is a circular shape, and is positioned on the upstream side in the filler neck 20. In the outer end portion on the upstream side of the neck main body 21, a screw thread 20s is formed, which can be screwed with a screw thread 30s in the inner end portion on the downstream side of the above-described first opening forming member 30. The neck connection portion 22 is positioned on the downstream side in the filler neck 20, and stretches out to the neck main body 21. The neck connection portion 22 is press-fitted into the fuel pipe 210. In the neck connection portion 22, a plurality of projections which protrude in an outer diameter direction in an annular shape and of which a section has a substantially right angled triangular shape are formed. That is, the neck connection portion 22 has a so-called fir tree-like external appearance shape. By employing such a structure, the neck connection portion 22 can be easily inserted by expanding the connection end of the fuel pipe 210 when press-fitted into the fuel pipe 210, and can be unlikely to fall out even when a force is applied in a direction in which the fuel pipe 210 is pulled out. The fuel vapor port 23 is a tube part branched from the side wall of the neck main body 21. The fuel vapor port 23 is connected to the fuel vapor pipe 220 illustrated in FIG. 1, and makes the fuel vapor fed from the fuel tank FT via the fuel vapor pipe 220 return to the inner flow path 11 when feeding oil.

Accordingly, the oil is smoothly fed. On the inner side of the fuel vapor port 23, a fuel vapor passage 23P is formed. The fuel vapor port 23 is formed such that the fuel vapor passage 23P is separated from the inner flow path 11 along the feeding direction D1. The fuel vapor port 23 is press-fitted into the fuel vapor pipe 220 illustrated in FIG. 1 in the end portion on the side opposite to the end portion that stretches out to the neck main body 21.

Here, the filler neck 20 of the present embodiment has a two-layered structure including an inner conductive polyamide layer 25 and an outer adhesive polyethylene layer 26, when viewed in a radial direction, that is, a direction of separating from the axial line CX, with the axial line CX as a starting point. In other words, all of the above-described neck main body 21, the neck connection portion 22, and the fuel vapor port 23 have the two-layered structure.

The conductive polyamide layer 25 is in contact with the inner flow path 11 on the inner surface, and is in contact with the adhesive polyethylene layer 26 on the outer surface. The conductive polyamide layer 25 is formed of a conductive polyamide (PA) composition, and has conductivity. In the present embodiment, an earth path is achieved by utilizing the conductivity of the conductive polyamide layer 25. A specific configuration of the conductive polyamide resin composition and details of the earth path will be described later. In addition, since the conductive polyamide layer 25 is formed by using the conductive polyamide resin composition of the present embodiment which will be described later in detail, it is possible to suppress deterioration of impact resistance, to ensure conductivity, to suppress deterioration of conductivity due to the fuel, and also to improve formability of the filler neck 20.

The adhesive polyethylene layer 26 is formed of an adhesive polyethylene (PE) resin composition. In the present embodiment, the adhesive polyethylene resin composition contains a modified polyethylene resin obtained by graft-modifying a polyethylene resin with unsaturated carboxylic acid or a derivative thereof. The polyethylene resin before the modification may be a homopolymer of ethylene or a copolymer of ethylene and another olefin. As the olefin copolymerized with ethylene, for example, use can be made of α-olefin having a carbon number of 2 to 10 such as propylene, 1-butene, 1-hexene, 4-methyl-1-pentene, 1-octene, and 1-decene. As the unsaturated carboxylic acid or derivative thereof, for example, use can be made of an unsaturated carboxylic acid such as acrylic acid, methacrylic acid, α-ethylacrylic acid, maleic acid, fumaric acid, itaconic acid, citraconic acid, tetrahydrophthalic acid, methyltetrahydrophthalic acid, and endocis-bicyclo[2,2,1]-hept-5-ene-2,3-dicarboxylic acid (nadic acid (registered trademark)); or a derivative such as acid halide, amide, imide, acid anhydride, and ester thereof. The graft-modification of the polyethylene resin can be performed by a known method, and for example, may be performed by dissolving the polyethylene resin into an organic solvent, and then, adding an unsaturated carboxylic acid or derivative thereof and a radical initiator to the obtained solution to undergo a reaction. In the case of using the adhesive polyethylene layer 26, it is possible to form a two-layered structure while improving adhesiveness with the conductive polyamide layer 25.

In the case where the outer layer in the above-described two-layered structure is formed by the adhesive polyethylene layer 26, it is possible to improve mechanical strength and impact resistance of the filler neck 20. In addition, in the case where conductivity is imparted only to the inner layer in the two-layered structure, it is possible to reduce a use amount of a material (carbon black which will be described later) for imparting conductivity, and to reduce manufacturing costs of the filler neck 20. In the present embodiment, the above-described two-layered structure is realized by two-color forming. Instead of the two-color forming, extrusion forming may also be employed.

As illustrated in FIG. 3, on the adhesive polyethylene layer 26 of the neck main body 21, in the vicinity of the fuel vapor port 23, an opening portion 24 is formed. Therefore, in the opening portion 24, the conductive polyamide layer 25 on the inner side is exposed. As illustrated in FIG. 2, in the opening portion 24, a part of the fixing member 600 illustrated by a broken line is disposed, and the fixing member 600 and the conductive polyamide layer 25 come into contact with each other.

The bracket 70 has a tubular external appearance shape, and as illustrated in FIG. 2 and FIG. 3, the bracket 70 is inserted to the neck main body 21 from the opening on the upstream side, and is mounted to cover the opening. The outer circumferential surface of the bracket 70 is in contact with the inner circumferential surface of the neck main body 21, that is, the inner surface of the conductive polyamide layer 25. The bracket 70 accommodates the second opening forming member 66 and the second valve device 60 on the inner side.

The second opening forming member 66 has a tubular external appearance shape, and as illustrated in FIG. 2 and FIG. 3, the second opening forming member 66 is disposed on the upstream side on the inner side of the bracket 70. An annular seal member 80 is disposed between the second opening forming member 66 and the bracket 70. The seal member 80 seals a gap between the outer circumferential side of the second opening forming member 66 and the inner circumferential side of the bracket 70. The second opening forming member 66 forms an inner opening IOP. In the inner opening IOP, the nozzle NZ is inserted when feeding oil.

The second valve device 60 is a device for opening and closing the inner opening IOP. As illustrated in FIG. 3, the second valve device 60 includes a valve body 61, a bearing portion 62 which rotatably supports the valve body 61 with respect to the second opening forming member 66, a spring 63 which biases the valve body 61 in a closing direction, a gasket 64, and a pressure regulating valve 65.

The valve body 61 is a member which is rotatable to the downstream side around the bearing portion 62. More specifically, the valve body 61 is rotatable in a direction R2 illustrated in FIG. 2. As illustrated in FIG. 3, the valve body 61 includes a pressing member 61a and a valve chamber forming member 61b, and a valve chamber in which the pressure regulating valve 65 is accommodated is formed. The gasket 64 is formed of a rubber material in an annular shape and is mounted on the outer circumferential portion of the valve body 61. The gasket 64 closes the inner opening IOP in a sealed state by being interposed between the outer circumferential portion of the valve body 61 and the circumferential edge portion of the inner opening IOP formed by the second opening forming member 66. The spring 63 is a torsion spring in which one end is fixed to the valve body 61 and the other end is disposed to be in contact with the inner circumferential surface of the neck main body 21, that is, the inner surface of the conductive polyamide layer 25. The pressure regulating valve 65 is accommodated in the valve chamber, includes a positive pressure valve biased by the spring 63, and releases the pressure on the fuel tank side by being opened when the pressure of the fuel tank exceeds a predetermined pressure.

In the present embodiment, in the second valve device 60, the valve body 61, the pressing member 61a, and the valve chamber forming member 61b are formed of the same composition as a conductive polyamide resin composition that forms the above-described conductive polyamide layer 25 and thus, has conductivity. In addition, in the present embodiment, the spring 63 is formed of stainless steel, and has conductivity. Here, not being limited to stainless (SUS) steel, the spring 63 may be formed of arbitrary metal having conductivity, such as aluminum (Al) and titanium (Ti), or an alloy of these metals. In addition, not being limited to metal, the spring 63 may be formed of a resin composition having conductivity.

Returning to FIG. 1, the fuel pipe 210 is a resin pipe which connects the opening forming portion 10 and the fuel tank to each other, and forms a part of the fuel flow path 510. At one end of the fuel pipe 210, as described above, the neck connection portion 22 of the filler neck 20 is press-fitted. At the other end of the fuel pipe 210, a part of the fuel tank tube connection device 110 is press-fitted. In the present embodiment, the fuel pipe 210 has a plural-layered structure configured of a plurality of layers. Specifically, the fuel pipe 210 has a plural-layered structure formed of, in order from the inner side to the outer side, adhesive polyethylene, ethylene-vinyl alcohol copolymer, adhesive polyethylene, and high-density polyethylene. The fuel pipe 210 may have a single-layered structure. For example, the fuel pipe 210 may have a single-layered structure formed of polyethylene (PE) having excellent fuel resisting properties.

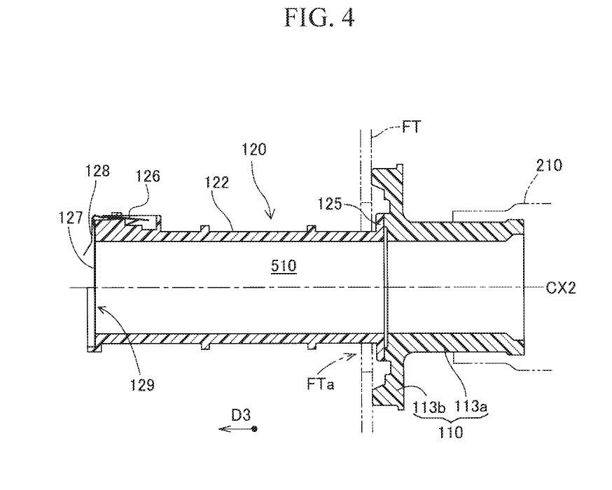

FIG. 4 is a sectional view illustrating a configuration of the fuel tank tube connection device 110 and the check valve 120. The fuel tank tube connection device 110 is a device for attaching the fuel pipe 210 to the fuel tank FT. The fuel tank tube connection device 110 includes a pipe portion 113a and a flange portion 113b, and has a structure in which the pipe portion 113a and the flange portion 113b are formed to be integrated with each other. Both the pipe portion 113a and the flange portion 113b have a hollow portion on the inner side, and axial lines thereof are identical to each other. These axial lines are identical to an axial line CX2 of the fuel tank tube connection device 110, and is also identical to the axial line of the check valve 120. In the fuel tank tube connection device 110 and the check valve 120, the fuel flows along a direction D3 parallel to the axial line CX2.

The pipe portion 113a has a tubular external appearance shape, and one end side of the pipe portion 113a is press-fitted into the fuel pipe 210 and the other end stretches out to the flange portion 113b. Here, the end portion of the fuel pipe 210 press-fitted into one end of the pipe portion 113a is fastened by a clamp which is not illustrated. The flange portion 113b is a substantially disk-shaped part which protrudes in the outer diameter direction from the pipe portion 113a, and the outer diameter end of the flange portion 113b protrudes in the direction D3. At the outer diameter end of the flange portion 113b, the fuel tank tube connection device 110 is welded to the fuel tank FT. The part near the axial line CX2 in the flange portion 113b is welded to the end portion (end portion 125 which will be described later) on the upstream side of the check valve 120. In the fuel tank FT, at the part at which the fuel tank tube connection device 110 and the check valve 120 are attached, an opening FTa is formed, and the flange portion 113b is welded to the fuel tank FT to surround the opening FTa. In the present embodiment, the fuel tank tube connection device 110 has a single-layered structure formed of the polyamide (PA).

The check valve 120 has a tubular external appearance shape, the end portion thereof on the upstream side is welded to the flange portion 113b of the fuel tank tube connection device 110, and in the other end portion thereof on the downstream side is formed a feeding port 129 which feeds the fuel into the fuel tank FT. The check valve 120 includes a passage forming member 122, a valve plate 127, a regulating member 128, and an attaching portion 126. The passage forming member 122 has a tubular external appearance shape. The end portion 125 on the upstream side of the passage forming member 122 is formed in a flange shape, and is welded to a root part of the flange portion 113b of the fuel tank tube connection device 110. In the other end portion on the downstream side of the passage forming member 122, the above-described feeding port 129 is formed. Where the fuel is not being fed, the feeding port 129 is blocked by the valve plate 127 as illustrated in FIG. 4. In the present embodiment, the passage forming member 122 has a single-layered structure formed of polyamide (PA) similar to the fuel tank tube connection device 110.

The valve plate 127 is attached to the end portion on the downstream side of the passage forming member 122 together with the regulating member 128 by the attaching portion 126. The valve plate 127 is integrally formed as a plate spring by press-cutting and bending a metal-made thin plate. In the present embodiment, the valve plate 127 is formed of stainless steel. Instead of stainless steel, the valve plate 127 may be formed of an arbitrary metal such as copper or titanium, or an alloy thereof. When feeding fuel, a posture of the valve plate 127 changes to open the feeding port 129 with the vicinity of the attaching portion 126 as an axis by being pressed in the feeding direction D3 due to the fuel fed. When the feeding of the fuel is stopped, the posture is changed to block the feeding port 129 by a biasing force of the plate spring of the valve plate 127 itself. The regulating member 128 is a member having a thin plate shape which is bent at two locations, and regulates a certain amount or more of inclination when the valve plate 127 is inclined by being pressed due to the fuel. Specifically, in the case where the valve plate 127 is open and the opening degree of the feeding port 129 is large, a regulating portion 38 comes into contact with the valve plate 127 to regulate the rotation of the valve plate 127 more than that when the opening degree reaches a certain opening degree.

As illustrated in FIG. 1, the fuel vapor pipe 220 is connected to the fuel tank FT and the fuel vapor port 23 of the filler neck 20. The fuel vapor pipe 220 feeds the fuel vapor in the fuel tank FT to the inner flow path 11 of the neck main body 21. A fuel vapor pipe 220 is connected to the fuel tank FT via a valve device BV provided in the fuel tank FT. The valve device BV suppresses fluid such as fuel, fuel vapor and air from flowing into the fuel tank FT via the fuel vapor pipe 220. In the present embodiment, similar to the fuel pipe 210, the fuel vapor pipe 220 has a single-layered structure formed of the polyethylene (PE) having excellent fuel resisting properties.

### A2. Earth Electric Discharge:

There has been a demand that it is desired to discharge static electricity charged to an oil feed gun when a user feeds oil by using the oil feed gun. In general, a vehicle main body BD of a vehicle is configured to be capable of performing earth electric discharge via a tire. The opening forming portion 10 of the present embodiment forms an earth path from the nozzle NZ of an oil feed gun to the vehicle main body BD.

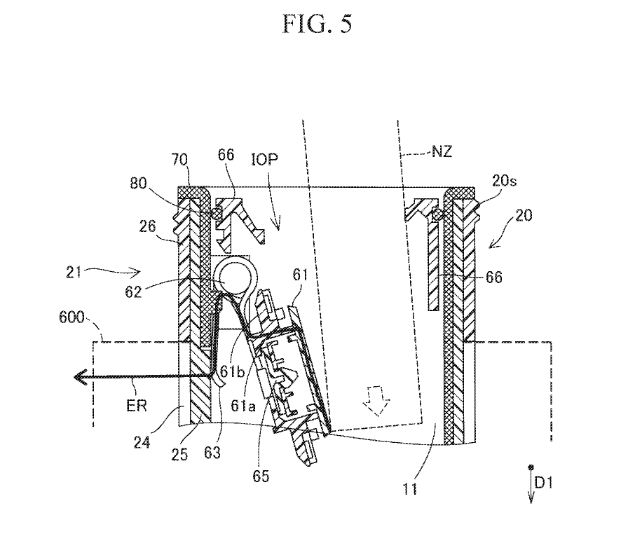

FIG. 5 is a sectional view illustrating an appearance of the filler neck 20 when feeding fuel. In FIG. 5, in the filler neck 20, a part on the upstream side in the neck main body 21 is illustrated, and a part on the downstream side in the neck main body 21, the fuel vapor port 23, and the neck connection portion 22 are omitted.

When the nozzle NZ is inserted into the inside of the opening forming portion 10 from the opening OP, the second valve device 60 is pressed down by the tip end of the nozzle NZ, and as illustrated in FIG. 5, the inner opening IOP is open. At this time, the nozzle NZ comes into contact with the valve body 61.

As described above, the valve body 61, the pressing member 61a, and the spring 63 have conductivity. In addition, one end of the spring 63 comes into contact with the conductive polyamide layer 25. Furthermore, the fixing member 600 comes into contact with the conductive polyamide layer 25 via the opening portion 24 formed in the adhesive polyethylene layer 26. In addition, the fixing member 600 is attached to the vehicle main body BD. Therefore, as indicated by an arrow of a thick solid line in FIG. 5, an earth path ER which reaches the vehicle main body BD through the valve body 61, the pressing member 61a, the spring 63, the conductive polyamide layer 25, and the fixing member 600 from the nozzle NZ is formed, and the electricity charged to the nozzle NZ is discharged through the earth path ER. In the present embodiment, since the conductive polyamide layer 25 is formed of a conductive polyamide resin composition which will be described later in detail, suppression of deterioration of conductivity caused by the fuel is realized. Therefore, deterioration of the above-described earth path ER over time can be suppressed. In other words, it is possible to ensure the earth path ER even when the fuel feed apparatus 500 is used for a long period of time.

### A3. Configuration of Conductive Polyamide Resin Composition:

A specific configuration of the conductive polyamide resin composition which forms the conductive polyamide layer 25 of the above-described filler neck will be described hereinafter.

The conductive polyamide resin composition of the present embodiment contains (A) 84 to 40% by weight of a polyamide resin, (B) 5 to 30% by weight of conductive carbon black, (C) 3 to 30% by weight of an ethylene-α-olefin copolymer containing a reactive functional group that can react with a terminal group and/or an amide group in a main chain of the polyamide resin, and (D) 1 to 20% by weight of a conductive polyethylene resin. In addition, the conductive polyamide resin composition of the present embodiment satisfies the following characteristics (a) and (b).

(a) Initial volume resistivity of a flat plate (100 mm×100 mm×2 mm (thickness)) obtained by injection forming the conductive polyamide resin composition is 1×10₅ Ω*cm or less, and volume resistivity after exposing the flat plate to CM15 fuel for 168 hours is 1×10⁷ Ω·cm or less.

(b) Charpy impact strength at −40° C. of a test piece obtained by injection forming the conductive polyamide resin composition is 2.0 KJ/m² or greater.

A content of each component is a ratio (% by weight) in the conductive polyamide resin composition. The characteristic (a) is achieved by controlling the morphology structure of the conductive polyamide resin composition which will be described later. CM15 fuel is fuel in which 15% by weight of methanol is contained in Fuel-C (isooctane/toluene=1/1 (volume)).

Regarding conductivity of the conductive polyamide resin composition of the present embodiment, even under the environment that the conductive polyamide resin composition comes into contact with alcohol-containing fuel, deterioration in conductivity can be suppressed, and volume resistivity after being exposed to the CM15 fuel for 168 hours can reach a value which is equal to or less than 1×10⁷ Ω·cm. The volume resistivity after being exposed to the CM15 fuel for 168 hours is preferably 1×10⁶ Ω·cm or less, and more preferably 5×10⁵ Ω·cm or less.

In addition, excellent impact resistance at the low temperature and Charpy impact strength at −40° C. being equal to or greater than 2.0 KJ/m² can be achieved since the conductive polyamide resin composition has the following configuration. The Charpy impact strength is preferably 2.5 KJ/m² or greater.

Furthermore, the conductive polyamide resin composition of the present embodiment preferably has an excellent fluidity. Thus, the conductive polyamide resin composition of the present embodiment preferably has a melt index (ISO 1133 rule, 250° C., 10 kg of a load) of 2 g/10 minutes or greater, more preferably 3 g/10 minutes or greater, still more preferably 5 g/10 minutes or greater, and particularly preferably 10 g/10 minutes or greater. The melt index can be controlled within an appropriate range by regulating the amount of each component which will be described later.

The polyamide resin (A) used in the present embodiment is polyamide resin containing an acid amide bond (—CONH—) in a molecule. Specific examples thereof include a polymer or a copolymer which is obtained from ϵ-caprolactam, 6-aminocaproic acid, ω-enantholactam, 7-aminoheptanoic acid, 11-aminoundecanoic acid, 9-aminononanoic acid, α-pyrrolidone, and α-piperidine, or blend thereof; and a polymer or a copolymer which is obtained by polycondensating a diamine such as hexamethylenediamine, nonamethylenediamine, undecamethylenediamine, dodecamethylenediamine, or metaxylylenediamine with a dicarboxylic acid such as terephthalic acid, isophthalic acid, adipic acid, or sebacic acid, or blend thereof, but the present invention is not limited thereto. From the viewpoint of easy availability, polyamide 6 and polyamide 66 are preferable.

Among these types of polyamide resin, a resin having a number average molecular weight of 7,000 to 30,000 is preferably used. There is a tendency that toughness deteriorates when the number average molecular weight is less than 7,000, and fluidity deteriorates when the number average molecular weight exceeds 30,000. In terms of relative viscosity (measured in a solution of 98% sulphuric acid), the relative viscosity is preferably from 1.5 to 4.0. The content of the polyamide resin (A) is 84 to 40% by weight, and more preferably 70 to 50% by weight. In the case where the content of the polyamide resin is less than 40% by weight, in a microstructure of a formed article (e.g., filler neck 20) made of the conductive polyamide resin composition, the morphology structure where the polyamide resin is to be a continuous phase becomes unstable, which is not preferable.

The conductive carbon black (B) used in the present embodiment is not particularly limited, and use can be made of Ketjen black, acetylene black, furnace black, channel black, or the like. Among these, Ketjen black is particularly preferable since Ketjen black exhibits excellent conductivity with a small content. The content of the conductive carbon black (B) depends on the degree of a target conductivity, but 5 to 30% by weight is appropriate. The content of the conductive carbon black (B) is preferably 15 to 30% by weight, and more preferably 20 to 30% by weight.

It is preferable that 80% by weight or more of the content of the conductive carbon black disperses in the polyamide resin that forms the continuous phase of the conductive polyamide resin composition. For this, a kneading process is extremely important, and a functional group such as a carboxy group or a hydroxy group, which exists on a particle surface of the carbon black is also important. The functional group on the surface of the carbon black acts to increase affinity with respect to the polyamide resin by sufficient kneading in the kneading process, whereby dispersion to the continuous phase of the polyamide resin becomes easy. In the present invention, a kneading condition, a concentration of the functional group on the surface of carbon black or the like is not particularly limited, but it is important that 80% by weight or more of the content of the carbon black is dispersed in the polyamide resin which is the continuous phase in the formed article of the conductive polyamide resin composition. Due to the dispersion of the carbon black in this manner, a composition having an excellent conductivity in which the volume resistivity is 1×10⁵ fl-cm or less is obtained. In addition, other physical properties also become excellent.

As a polymer that serves as a basic structure of the ethylene-α-olefin copolymer (C) (hereinafter, which may be also referred to as a modified ethylene-α-olefin copolymer or a modified olefin copolymer in some cases) having a functional group that can react with a terminal group and/or an amide group in a main chain of the polyamide resin, which is used in the present embodiment, examples thereof include an ethylene/propylene copolymer, an ethylene/propylene/diene copolymer, an ethylene/butene-1 copolymer, an ethylene/octene-1 copolymer, an ethylene/hexene-1 copolymer, an ethylene/4-methyl pentene-1 copolymer, and an ethylene/cyclic olefin copolymer, but the modified ethylene-α-olefin copolymer (C) is not limited thereto. The content of the modified ethylene-α-olefin copolymer (C) is 3 to 20% by weight, preferably 3 to 10% by weight, and more preferably 3 to 8% by weight.

The functional group that can react with a terminal group and/or an amide group in a main chain of the polyamide resin in the modified ethylene-α-olefin copolymer (C) used in the present embodiment, is a group that can react with an amino group or a carboxy group which are a terminal group of the polyamide resin, and an amino group in the main chain. Specific examples thereof include a carboxylic acid group, an acid anhydride group, an epoxy group, an oxadoline group, an amino group, and an isocyanate group, but among these, the acid anhydride group is preferable since the acid anhydride group is the most excellent in reactivity. In addition, it is needless to say that a large amount of the functional group makes the reaction with the polyamide resin proceed more, and thus, the modified ethylene-α-olefin copolymer is dispersed in finer particle diameters in the continuous phase of the polyamide resin, and impact resistance of the composition is also improved. Examples of the producing method of the modified ethylene-α-olefin copolymer having the functional groups include a method of making a compound having the above-described functional groups react in a process of producing the copolymer, or a method of mixing a compound having the functional groups with pellets of the copolymer and making them react with each other by kneading the mixture by an extruder, but the method is not limited thereto.

The modified ethylene-α-olefin copolymer (C) used in the present embodiment preferably has a morphology structure in which the modified ethylene-α-olefin copolymer (C) is dispersed in a shape of particles having an average particle diameter of 2 μm or less in the polyamide resin which is the continuous phase. The above-described morphology structure is obtained by making the polyamide resin and the modified ethylene-α-olefin copolymer react to each other in the producing process of the composition. As the modified ethylene-α-olefin copolymer is finely dispersed with the average particle diameter of 2 μm or less in the polyamide resin, high shock characteristics are obtained.

The conductive polyethylene resin (D) used in the present embodiment is a resin in which a conductive carbon black (B_{D}) is contained being dispersed in polyethylene in advance. The conductive polyethylene resin (D) preferably has a volume specific resistivity of 1 Ω·cm or greater and 1×10⁷ Ω·cm or less, and preferably contains 5 to 20% by weight of the conductive carbon black (B_{D}) (as a ratio (% by weight) in the conductive polyethylene resin (D)).

Polyethylene which configures the conductive polyethylene resin (D) can be obtained by homopolymerizing ethylene or by copolymerizing ethylene with an α-olefin having a carbon number of 3 to 12 such as propylene, 1-butene, 1-pentene, 1-hexene, 4-methyl-1-pentene, or 1-octene. In addition, in a case of aiming for modification, copolymerization with diene is also possible. Examples of a diene compound used at this time include butadiene, 1,4-hexadiene, ethylidene norbornane, and dicyclopentadiene.

Here, the comonomer content during polymerization can be arbitrarily selected, but for example, in the case of copolymerizing ethylene and an α-olefin having a carbon number of 3 to 12, the content of the α-olefin in the ethylene-α-olefin copolymer is preferably 0 to 40 mol %, and more preferably 0 to 30 mol %.

As polyethylene which configures the conductive polyethylene resin (D), high-density polyethylene having a density of equal to or greater than 0.96 is preferable from the viewpoint of fuel resisting properties and sliding properties.

Example of a commercially available product of the conductive polyethylene resin include conductive polyethylene GM9350C manufactured by LyondellBasell Industries Holdings B.V.

Examples of the conductive carbon black (B_{D}) which configures the conductive polyethylene resin (D) include acetylene black, conductive furnace black, superconductive furnace black, conductive channel black, and furnace black or channel black which is heat-processed at a high temperature of approximately 1,500° C., and the Ketjen black which is one type of furnace black can be also employed. Among these, Ketjen black having a hollow shell structure of which the center of a primary particle is hollow is preferable.

The content of the conductive polyethylene resin (D) is 1 to 20% by weight, preferably 2 to 10% by weight, and more preferably 3 to 8% by weight. In the case where the content of the conductive polyethylene resin (D) is less than 1% by weight, an effect of improving fuel resisting properties is small, and in the case of exceeding 20% by weight, there is a concern that impact resistance deteriorates. In the composition of the present invention, the modified ethylene-α-olefin copolymer dispersed in the polyamide resin and the polyethylene which configures the conductive polyethylene resin are the same type of olefin-based resin and have excellent affinity, and thus, dispersibility in the composition are excellent, and conductive carbon blacks can effectively exhibit their conductivity.

The morphology structure of the conductive polyamide resin composition of the present embodiment is extremely important. The polyamide resin (A) configures a continuous phase that becomes a matrix, and by reacting with the polyamide resin, the modified ethylene-α-olefin copolymer (C) which is finely dispersed can has a dispersion average particle diameter of equal to or less than 2 μm. Furthermore, 80% by weight or more of the content of the conductive carbon black (B) is dispersed in the polyamide resin (A) which becomes the continuous phase, by regulating a kneading condition and the functional group which exists on the surface of the particle. In addition, the conductive polyethylene resin (D) is uniformly dispersed while containing the conductive carbon black (B_{D}) due to the affinity with the modified ethylene-α-olefin copolymer that is finely dispersed. Therefore, the conductive carbon black (B_{D}) in the polyethylene can be close to the conductive carbon black (B) in the polyamide resin, and can contribute to achieving conductivity of the composition. Furthermore, since oil absorbing properties of the conductive carbon blacks are unlikely to be developed due to polyethylene which is unlikely to be swollen by fuel or alcohol-containing fuel, it is possible to suppress deterioration of conductivity caused by the fuel or the alcohol-containing fuel.

In order to control the above-described morphology structure, a mixing method of each component is important. It is effective that after dispersing the conductive carbon black (B) in the polyamide resin (A) in advance, the ethylene-α-olefin copolymer (C) having a reactive functional group that can react with the polyamide resin and the conductive polyethylene resin (D) are blended thereto, thereby obtaining the conductive polyamide resin composition.

In addition to the components of the above-described (A), (B), (C), and (D), the conductive polyamide resin composition of the present embodiment may contain a copper oxide which is a weather resistance improving material used in a general polyamide resin composition, and/or alkali metal halide, a phenolic antioxidant or a phosphorous-based antioxidant which serves as a light or heat stabilizer, a releasing agent, a nucleating agent, a lubricant, a pigment, a dye, or the like.

The conductive polyamide resin composition of the present invention preferably contains 80% by weight or more in the total amount of each component of (A), (B), (C), and (D), more preferably 90% by weight or more, and still more preferably 95% by weight or more.

The conductive polyamide resin composition of the present embodiment may be not able to form a stabilized morphology structure only by blending each component to each other and kneading the components simply by an extruder. It is recommended to knead the components by a special method. For example, after melt-kneading the polyamide resin (A) and the conductive carbon black (B) in a melt-kneader (e.g., a twin screw extruder or a melt-reaction tank) to uniformly disperse the carbon black in the polyamide resin, the modified ethylene-α-olefin copolymer (C) and the conductive polyethylene resin (D), and other additives as necessary are added thereto, followed by further melt-kneading.

By the two-stepped melt-kneading, it is possible to stably produce the polyamide conductive resin component having the morphology structure of the present invention.

However, the producing method of the polyamide conductive resin composition of the present invention is not limited to the specific blending or the melt-kneading method, and it is possible to produce the composition of the present invention by using another blending and another method as long as the above-described compositions and morphology structure are obtained. In Examples which will be described later, specific contents of the conductive polyamide resin composition will be further described.

According to the filler neck 20 which is the component for a fuel feed apparatus of the above-described first embodiment, since a predetermined amount of the ethylene-α-olefin copolymer (C) having a reactive functional group that can react with a terminal group and/or an amide group in a main chain of the polyamide resin is contained, the conductive polyamide resin composition that forms the conductive polyamide layer can impart impact resistance and realize dispersion of the conductive carbon black (B). In addition, since a predetermined amount of the conductive polyethylene resin (D) is contained, the conductive polyethylene resin (D) can uniformly disperse while containing conductive carbon black (B_{D}). Therefore, the conductive carbon black (B_{D}) in the conductive polyethylene resin (D) can be close to the conductive carbon black (B) in the polyamide resin, and can contribute to achieving conductivity of the composition. In addition, since oil absorbing properties of the conductive carbon blacks are unlikely to be developed due to polyethylene which is unlikely to be swollen by fuel or alcohol-containing fuel, deterioration of conductivity caused by the fuel or the alcohol-containing fuel can be supressed. Further, since the polyamide resin (A), the conductive carbon black (B), and the ethylene-α-olefin copolymer (C) having a reactive functional group that can react with the terminal group and/or the amide group in the main chain of the polyamide resin are contained, fluidity and formability can be improved. In addition, in a microstructure in the conductive polyamide layer 25 of the filler neck 20, the morphology structure in which the polyamide resin is to be a continuous phase can be stabilized.

In addition, since the conductive polyamide resin composition of the present embodiment satisfies the characteristic (c) in which the melt index measured at a temperature of 250° C. and a load of 10 kgf is equal to or greater than 2 g/10 min, it is possible to improve fluidity of the conductive polyamide resin composition, and to improve formability of the filler neck 20 (conductive polyamide layer 25). In addition, since the polyethylene of the conductive polyethylene resin (D) is high-density polyethylene, it is possible to improve fuel resisting properties and sliding properties.

In addition, since the adhesive polyethylene layer 26 that is configured to be in contact with the outer surface of the conductive polyamide layer 25 is provided, it is possible to form the filler neck 20 in a two-layered structure while improving adhesiveness of both surfaces. Moreover, the filler neck 20 has fuel resisting properties, particularly, excellent fuel resisting properties with respect to the alcohol-containing fuel, and thus, it is possible to suppress deterioration of the fuel flow path over time even when being exposed to the fuel. In addition, since deterioration of conductivity is suppressed, it is possible to use the filler neck 20 as a part of the earth path ER from the oil feed gun (nozzle NZ) to the grounded part.

### B. Examples

Hereinafter, the conductive polyamide resin composition used in the above-described first embodiment will be described in more detail by Examples, but the present invention is not limited to any of the following Examples.

Respective characteristics and physical values which are illustrated in the following Examples and Comparative Examples were measured by the following test method. A test piece was formed according to the following condition by an injection forming machine (manufactured by Toshiba Machine Co., Ltd., IS80).

Resin temperature: 275° C.

Die temperature: 40° C.

Injection pressure: 50 kg/cm²

Injection time: 1 second

Pressure keeping: 60 kg/cm²

Holding time: 6 seconds

### 1. Volume Resistivity

Terminals were connected to both ends perpendicular to a gate of a plate having 100 mm×100 mm×2 mm (thickness) obtained by injection forming, and volume resistivity of the plate was measured by a digital multimeter (manufactured by Advantest Corp. TR-6843). The measurement test piece was subjected to the measurement after performing seasoning for 24 hours at an atmosphere of 20° C. and 50% RH after vacuum-drying the test piece at 70° C. for 12 hours.

### 2. Volume Resistivity (After Exposing to Fuel)

The CM15 fuel for immersing the test piece was prepared by blending methanol (manufactured by Nacalai Tesque, Inc., 99.5% of purity) into Fuel-C (isooctane/toluene=1/1 (volume)) to achieve 15% by weight. The test piece used in test method 1 was immersed therein, and the test was performed after setting the test piece in an oven at 60° C.

The test piece was taken out from the CM15 fuel after immersion for 168 hours, the solution that adhered to the surface was wiped out, and then the volume resistivity was measured by the same method as the test method 1 within one minute.

### 3. Notch Charpy Impact Strength

In accordance with ISO-179-leA, a dumbbell piece was prepared by the injection forming and a low-temperature Charpy impact strength was measured at −40° C.

### 4. Melt Index

The measurement was performed in accordance with ISO 1133. The measurement was performed at a temperature of 250° C. and at a load of 10 kgf.

### 5. Observation of Morphology Structure

A frozen slice was obtained from the center portion of a plate having 100 mm×10 mm×2 mm (thickness) obtained by the injection forming.

In measuring the average particle diameter of the modified ethylene-α-olefin copolymer (C), the frozen slice having a section perpendicular to the direction of a resin flow of a sample was prepared and dyed for 30 minutes by a 5%-phosphotungstic acid aqueous solution. Then, carbon deposition was performed, and then, the frozen piece was directly observed at an acceleration voltage of 200 KV and at a magnification of 5000 times by using a transmission electron microscope JEM 2010 manufactured by JEOL Ltd, and was photographed. Next, the obtained picture was applied to an image analysis device to acquire the average particle diameter. In the device, in the case where the observed image of a domain (dispersed phase) has an elliptical shape, the diameter converted into a sphere was regarded as a particle diameter.

As a location at which the conductive carbon black (B) exists, the number of all of the particles of the carbon blacks existing in the obtained picture and the number of the particles of carbon blacks existing in a continuous phase were counted by the image analysis device, and a percentage % of the number of particles of the conductive carbon black (B) existing in the continuous phase was regarded as % by weight. Incidentally, the carbon black (B_{D}) in the conductive polyethylene resin (D) existed in the dispersed phase other than the modified ethylene-α-olefin copolymer (C) within the dispersed phase and was able to be distinguished from the conductive carbon black (B), and the number of particles thereof was not counted as the carbon black existing in the picture.

As raw materials of the composition used in Examples and Comparative Examples, the following materials were used.

### Polyamide Resin (A):

A-1: Toyobo nylon T-840 (manufactured by Toyobo Co., Ltd., nylon 6, relative viscosity is 2.2)

### Conductive Carbon Black (B):

B-1: Furnace carbon 100 (manufactured by Lion Corporation)

B-2: Ketjen carbon EC (manufactured by Lion Corporation)

Modified ethylene-α-olefin Copolymer (C):

C-1: Modified olefin copolymer Tafmer (registered trademark) MH7020 (manufactured by Mitsui Chemicals, Inc., maleic anhydride-modified ethylene-α-olefin copolymer)

### Conductive Polyethylene Resin (D):

D-1: Conductive polyethylene GM9350C (manufactured by LyondellBasell Industries Holdings B.V., 10% by weight of conductive carbon black is dispersed in high-density polyethylene)

D-2: Conductive polyethylene, a development article having 20% by weight of carbon (manufactured by LyondellBasell Industries Holdings B.V., 20% by weight of conductive carbon black is dispersed in high-density polyethylene)

D′: High-density polyethylene MME001 (manufactured by Mitsui Chemicals, Inc.)

### Examples and Comparative Examples

Before the overall compounding, first, the polyamide resin and the conductive carbon black were melt-kneaded by a twin screw extruder (manufactured by Ikegai Co., Ltd., PCM30) to obtain weight proportions described in Table 1, and the resultant was set as a master batch pellet. Next, by using the obtained master batch pellets, a weight of each raw material was measured and the row materials were blended according to the composition proportions of Table 1., the mixture was melt-kneaded by the twin screw extruder (manufactured by Ikegai Co., Ltd., PCM30) while setting the temperature of a cylinder to 260° C., whereby the conductive polyamide resin composition pellets were obtained. By using the obtained conductive polyamide resin composition, each evaluation was performed. The results are described in Table 1.

TABLE 1

| | | | | | | | Comparative | |
|---|---|---|---|---|---|---|---|---|
| | | | Examples | | | | Examples | |
| | | | 1 | 2 | 3 | 4 | 1 | 2 |
| Resin | A-1 Polyamide 6 | | 56 | 56 | 63 | 63 | 56 | 56 |
| composition | B-1 Furnace carbon | | — | 24 | — | — | — | — |
| (% by weight) | B-2 Ketjen carbon | | 24 | — | 27 | 27 | 24 | 24 |
| | C-1 Modified olefin copolymer | | 5 | 5 | 5 | 5 | 20 | 15 |
| | D-1 Conductive polyethylene 1 | | 15 | 15 | 5 | — | — | — |
| | D-2 Conductive polyethylene 2 | | — | — | — | 5 | — | — |
| | D′ High-density polyethylene | | — | — | — | — | — | 5 |
| Morphology | Dispersion of conductive | | 100 | 100 | 100 | 100 | 100 | 100 |
| structure | carbon black (% by weight in | | | | | | | |
| | polyamide resin) | | | | | | | |
| | Diameter of modified olefin | | 0.5 | 0.5 | 0.5 | 0.5 | 0.3 | 0.2 |
| | copolymer (μm) | | | | | | | |
| Physical | Volume | Initial | 1.0E+04 | 1.0E+04 | 5.0E+04 | 5.0E+04 | 5.0E+04 | 5.0E+04 |
| properties | resistivity | After exposing | 1.0E+05 | 1.0E+05 | 5.0E+05 | 5.0E+05 | 5.0E+08 | 5.0E+07 |
| | (Ω · cm) | to fuel | | | | | | |
| | | Charpy impact (KJ/m²) | 5 | 5 | 3.5 | 3.5 | 15 | 10 |
| | | Melt index (g/10 min) | 3 | 3 | 25 | 15 | 10 | 8 |

### C. Second Embodiment

### C1. Device Configuration

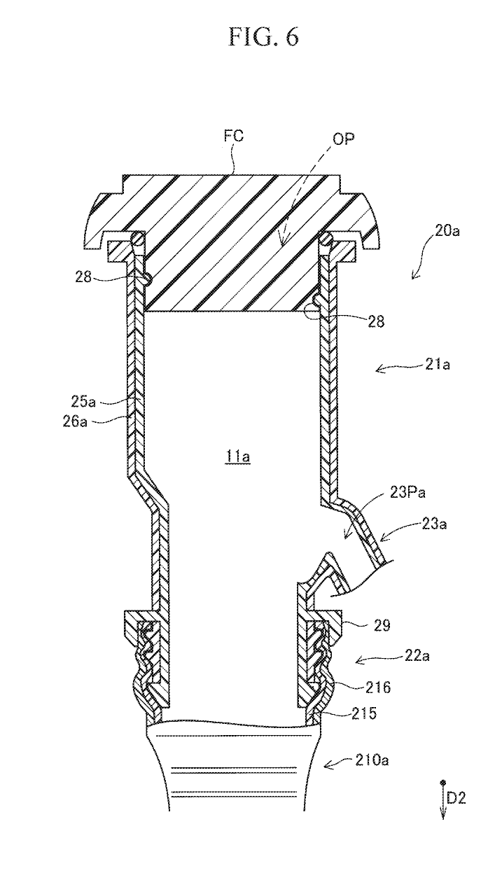

FIG. 6 is a sectional view illustrating a specific configuration of a filler neck 20a which serves as a component for a fuel feed apparatus of a second embodiment. The fuel feed apparatus of the second embodiment is different from the fuel feed apparatus 500 of the first embodiment in that a fuel pipe 210a is provided instead of the fuel pipe 210, the filler neck 20a is provided instead of the opening forming portion 10, and a fuel tank tube connection device 110a is provided instead of the fuel tank tube connection device 110, and the other configurations are the same as those of the fuel feed apparatus 500. In the fuel feed apparatus 500 of the first embodiment, the opening forming portion 10 has a so-called capless structure in which the opening OP is opened and closed without using a fuel cap, but in the fuel feed apparatus of the second embodiment, the opening OP is opened and closed by using a fuel cap FC. FIG. 6 illustrates a state where the fuel cap FC is mounted on the filler neck 20a, and the opening OP is closed by the fuel cap FC.

The fuel pipe 210a of the second embodiment is different from the fuel pipe 210 of the first embodiment, and has a two-layered structure. Specifically, the fuel pipe 210a has a two-layered structure made of an inner layer 215 and an outer layer 216. In the second embodiment, the inner layer 215 is formed of the same composition as the conductive polyamide resin composition that forms the conductive polyamide layer 25 of the first embodiment. In addition, in the second embodiment, the outer layer 216 is formed of the same composition as the adhesive polyethylene composition that forms the adhesive polyethylene layer 26 of the first embodiment. Therefore, in the second embodiment, the fuel pipe 210a has conductivity on the inner layer 215.

The filler neck 20a has a structure which is similar to the filler neck 20 of the first embodiment. In other words, the filler neck 20a has a tubular external appearance shape, and forms an inner flow path 11a which is a part of the fuel flow path 510. The filler neck 20a includes a neck main body 21a, a fuel vapor port 23a, and a neck connection portion 22a.

The neck main body 21a has a configuration similar to the neck main body 21 of the first embodiment. The end portion on the side opposite to a feeding direction D2 in the neck main body 21a forms the opening OP. Here, the feeding direction D2 means the same direction as the direction D1 of the above-described first embodiment. On the inner side on the upstream side of the neck main body 21a, a screw thread 28 is formed, and a screw thread formed on the outer circumferential surface of the fuel cap FC is screwed. The fuel vapor port 23a has the same configuration as the fuel vapor port 23 of the first embodiment, and forms a fuel vapor passage 23Pa on the inside.

The neck connection portion 22a has a fir tree-like external appearance shape similar to the neck connection portion 22 of the first embodiment. On the upstream side of the neck connection portion 22a, a claw-shaped conductive outer layer contact portion 29 which protrudes in the outer diameter direction is formed. In the second embodiment, the conductive outer layer contact portions 29 are provided at two locations at positions which are symmetric to each other at the outer circumference of the filler neck 20a. The gap between the outer circumferential surface of the neck connection portion 22a and the inner surface of the conductive outer layer contact portion 29 is formed to be smaller than a thickness of the fuel pipe 210a. And as illustrated in FIG. 6, when the fuel pipe 210a is connected to the filler neck 20a, the fuel pipe 210a comes into contact with the filler neck 20a in a state where the connection end of the fuel pipe 210a is interposed between the neck connection portion 22a and the conductive outer layer contact portion 29, and the conductive outer layer contact portion 29 is bitten into the outer layer 216 of the fuel pipe 210a. As the end portion in the feeding direction D2 of a conductive polyamide layer 25a and the inner layer 215 come into contact with each other, the filler neck 20a and the fuel pipe 210a are electrically connected to each other.

The filler neck 20a of the second embodiment has a two-layered structure similar to the filler neck 20 of the first embodiment. Specifically, the filler neck 20a has a two-layered structure configured of the conductive polyamide layer 25a and an adhesive polyethylene layer 26a. The conductive polyamide layer 25a forms a layer on an inner side similar to the conductive polyamide layer 25 of the first embodiment, and is formed of the same conductive polyamide resin composition as that of the conductive polyamide layer 25. The adhesive polyethylene layer 26a forms a layer on the outer side similar to the adhesive polyethylene layer 26 of the first embodiment, and is formed of the same adhesive polyethylene composition as that of the adhesive polyethylene layer 26.

The above-described conductive outer layer contact portion 29 is formed of the same composition as the conductive polyamide resin composition that forms the conductive polyamide layer 25a, and is formed by an injection forming to be integrated with the conductive polyamide layer 25a. Therefore, the conductive outer layer contact portion 29 has conductivity. The conductive outer layer contact portion 29 is provided to protrude in the outer diameter direction from the substantially tubular conductive polyamide layer 25a, and to penetrate the adhesive polyethylene layer 26a.

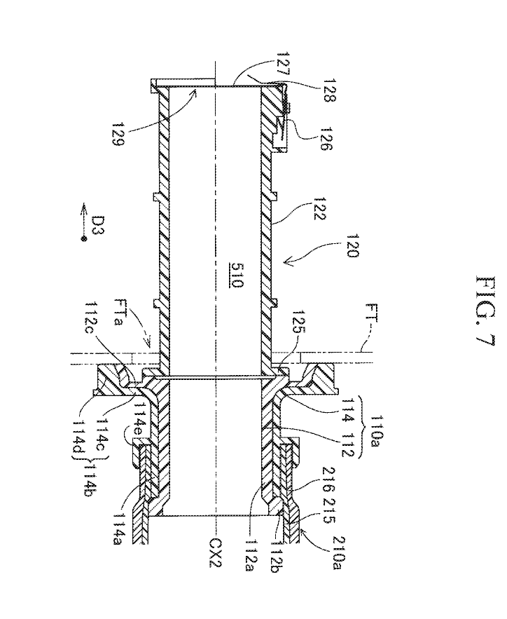

FIG. 7 is a sectional view illustrating the fuel tank tube connection device 110a of the second embodiment. In FIG. 7, similar to FIG. 4, both the check valve 120 and the fuel pipe 210a are also illustrated. The fuel tank tube connection device 110a of the second embodiment is different from the fuel tank tube connection device 110 of the first embodiment, and has a two-layered structure. Specifically, the fuel tank tube connection device 110a includes an inner layer 112 and an outer layer 114. The inner layer 112 is positioned on the inner side (inner diameter side) of the outer layer 114. The inner layer 112 is formed of the same composition as the conductive polyamide resin composition that forms the conductive polyamide layer 25 of the first embodiment. In addition, the outer layer 114 is formed of the same composition as the adhesive polyethylene composition that forms the adhesive polyethylene layer 26 of the first embodiment. Therefore, in the second embodiment, the fuel tank tube connection device 110a has conductivity on the inner layer 112. The inner layer 112 and the outer layer 114 are formed to be integrated by reactive adhesion by two-color forming.

The inner layer 112 has a substantially cylindrical external appearance shape, and includes a passage portion 112a press-fitted into the fuel pipe 210a. In one end portion of the passage portion 112a, a locking expansion portion 112b is formed. On the outer side of the locking expansion portion 112b, the outer layer 114 does not exist. The locking expansion portion 112b suppresses the falling-out of the fuel pipe 210a by the expansion in the outer diameter direction from the outer circumferential end of a passage portion 112a. In addition, as the locking expansion portion 112b comes into contact with the inner layer 215, the fuel pipe 210a and the fuel tank tube connection device 110a are electrically connected to each other. In the passage portion 112a, in the end portion opposite to the end portion in which the locking expansion portion 112b is formed, a disk-shaped first flange 112c which protrudes in the radial direction is formed. The end portion (side surface on the downstream side) in the feeding direction D3 of the first flange 112c is welded to the fuel tank FT. Therefore, the earth path which is continuous to the fuel tank FT via the fuel tank tube connection device 110a from the fuel pipe 210a is formed.

The outer layer 114 has a substantially cylindrical external appearance shape, and includes an outer pipe portion 114a, a second flange portion 114b, and an outer layer contact portion 114e. The outer pipe portion 114a has a cylindrical external appearance shape, and is disposed to be in contact with the outer circumferential surface of the passage portion 112a of the inner layer 112. The second flange portion 114b stretches out to the end portion on the downstream side of the outer pipe portion 114a, and has a disk-shaped external appearance shape which protrudes in the radial direction. The second flange portion 114b includes a first welding portion 114c, and a second welding portion 114d stretched out to the end portion in the outer diameter direction of the first welding portion 114c. The inner surface of the first welding portion 114c, that is, the downstream side surface of the first welding portion 114c is welded with the first flange 112c. The end portion of the first flange 112c is in contact with the inner surface in the inner diameter direction of the second welding portion 114d. The surface on the downstream side of the second welding portion 114d is welded to the fuel tank FT.

The outer layer contact portion 114e protrudes in the outer diameter direction from the substantially center portion along the direction D3 in the outer pipe portion 114a, and has a claw-shaped external appearance shape. Specifically, the outer layer contact portion 114e has a substantially L-shaped external appearance shape in which a part parallel to the outer diameter direction and a part parallel to the direction D3 intersect with each other at the end portions thereof. In the second embodiment, the outer layer contact portions 114e are provided at two locations at positions symmetric to each other at the outer circumference of the outer pipe portion 114a. The gap between the outer circumferential surface of the outer pipe portion 114a and the inner surface of the outer layer contact portion 14e is formed to be smaller than a thickness of the fuel pipe 210a. And as illustrated in FIG. 7, when the fuel pipe 210a is connected to the fuel tank tube connection device 110a, the fuel pipe 210a comes into contact with the fuel tank tube connection device 110a in a state where the connection end of the fuel pipe 210a is interposed between the outer pipe portion 114a and the outer layer contact portion 114e, and the outer layer contact portion 114e is bitten into the outer layer 216 of the fuel pipe 210a.

As described above, since the filler neck 20a and the fuel pipe 210a are electrically connected to each other, and the fuel pipe 210a and the fuel tank tube connection device 110a are electrically connected to each other, with the nozzle NZ as a starting point, the earth path which is continuous to the fuel tank FT via the filler neck 20a, the fuel pipe 210a, and the fuel tank tube connection device 110a is formed. In a configuration in which the fuel tank FT is attached to the vehicle main body BD by an attaching fitting or the like which is not illustrated, the earth path to the vehicle main body BD from the fuel tank FT exists. Therefore, for example, in the case where the nozzle NZ is inserted into the inner flow path 11a for feeding the fuel, and comes into contact with the conductive polyamide layer 25a of the filler neck 20a, regarding the nozzle NZ as a starting point, the earth path which reaches the vehicle main body BD through the conductive polyamide layer 25a of the filler neck 20a, the inner layer 215 of the fuel pipe 210a, the inner layer 112 (the locking expansion portion 112b and the passage portion 112a) of the fuel tank tube connection device 110a, the fuel tank FT, and the attaching fitting which is not illustrated, is formed, and electricity charged to the nozzle NZ is discharged through the earth path.

The filler neck 20a of the second embodiment having the above-described configuration has an effect similar to that of the filler neck 20 of the first embodiment. In the second embodiment, the filler neck 20a, the fuel pipe 210a, and the fuel tank tube connection device 110a correspond to a subordinate concept of the component for a fuel feed apparatus as mentioned in the summary of the present invention.

### C2. First Modification Example of Second Embodiment

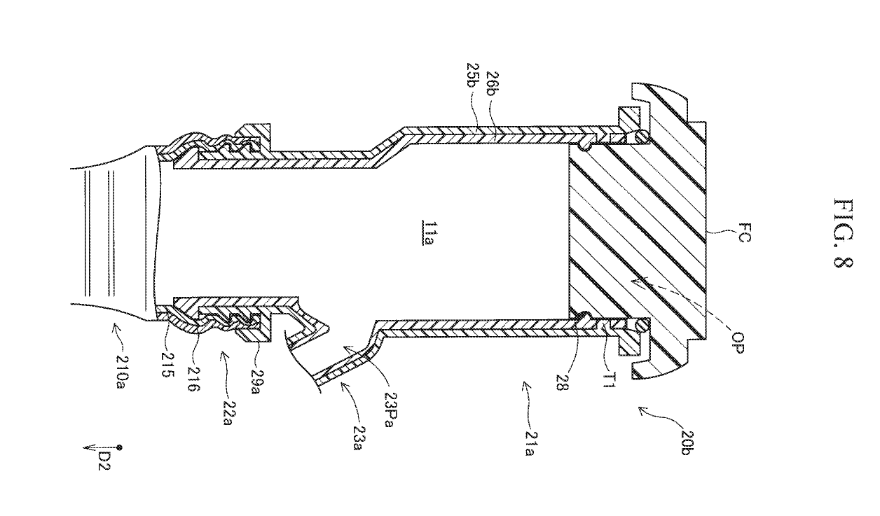

FIG. 8 is a sectional view illustrating a specific configuration of a filler neck 20b which is a first modification example of the second embodiment. The filler neck 20b of the first modification example of the second embodiment has a two-layered structure similar to the second embodiment. However, the filler neck 20b is different from the second embodiment in that the inner layer is an adhesive polyethylene layer 26b and the outer layer is a conductive polyamide layer 25b, in that the neck main body 21a includes a fuel cap contact portion T1, and in that a conductive outer layer contact portion 29a is provided instead of the conductive outer layer contact portion 29. The other configurations in the filler neck 20b of the first modification example of the second embodiment are the same as those of the filler neck 20a of the second embodiment, and the same configuration elements will be given the same reference numbers, and the specific description thereof will be omitted.

The fuel cap contact portion T1 is formed of the same composition as the conductive polyamide resin composition that forms the conductive polyamide layer 25b, and is formed by an injection forming to be integrated with the conductive polyamide layer 25b. The fuel cap contact portion T1 protrudes in the inner diameter direction from the conductive polyamide layer 25b having a substantially pipe shape, and is provided in a shape of a column (shape of a projection) penetrating the adhesive polyethylene layer 26b. When the fuel cap FC is mounted on the filler neck 20b and the fuel cap contact portion T1 comes into contact with the fuel cap FC, the fuel cap FC and the filler neck 20b are electrically connected to each other.

The conductive polyamide layer 25b is formed of the same conductive polyamide resin composition as that of the conductive polyamide layer 25a of the second embodiment. The adhesive polyethylene layer 26b is formed of the same adhesive polyethylene composition as that of the adhesive polyethylene layer 26a of the second embodiment.

The conductive outer layer contact portion 29a is formed of the same conductive polyamide resin composition as that of the conductive polyamide layer 25b, and is formed by an injection forming to be integrated with the conductive polyamide layer 25b.

According to the filler neck 20b of the first modification example of the second embodiment having the above-described configuration, an effect similar to that of the filler neck 20a of the second embodiment is achieved. In addition, with the fuel cap FC as a starting point, the earth path which reaches the vehicle main body BD through the fuel cap contact portion T1, the conductive polyamide layer 25b, the inner layer 215 of the fuel pipe 210a, the fuel tank tube connection device 110a, the fuel tank FT, and the attaching fitting which is not illustrated, is formed. Therefore, when opening the fuel cap FC and feeding fuel, it is possible to rapidly release static electricity charged to a human body or the like through the earth path. In the first modification example of the second embodiment, the filler neck 20b, the fuel pipe 210a, and the fuel tank tube connection device 110a correspond to a subordinate concept of the component for a fuel feed apparatus as mentioned in the summary of the present invention.

### C3. Second Modification Example of Second Embodiment

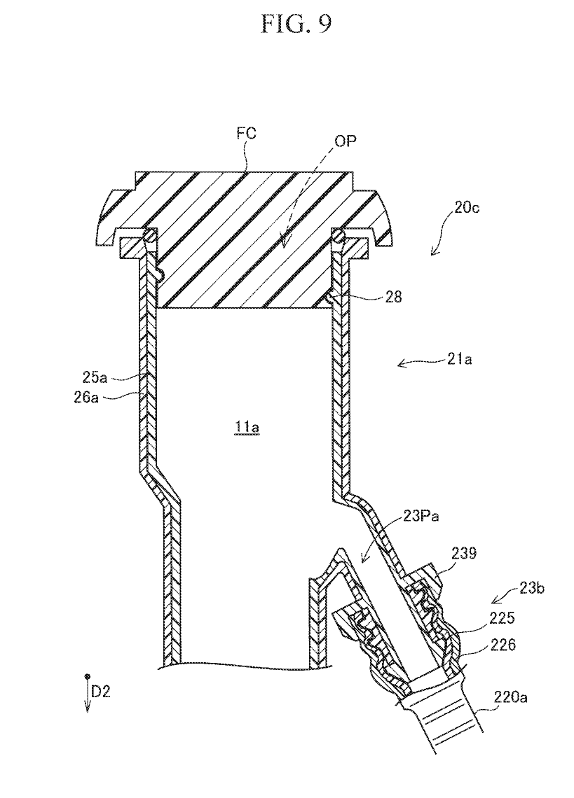

FIG. 9 is a sectional view illustrating a specific configuration of a filler neck 20c which is a second modification example of the second embodiment. The filler neck 20c of the second modification example of the second embodiment is different from the filler neck 20a of the second embodiment in that a fuel vapor port 23b is provided instead of the fuel vapor port 23a, and in that the conductive outer layer contact portion 29 is omitted. In addition, the fuel feed apparatus of the second modification example is different from the fuel feed apparatus of the second embodiment in that the above-described filler neck 20c is provided instead of the filler neck 20a, and in that a fuel vapor pipe 220a is provided instead of the fuel vapor pipe 220.

The fuel vapor pipe 220a is different from the fuel vapor pipe 220 of the second embodiment and has a two-layered structure. Specifically, the fuel vapor pipe 220a has a two-layered structure including an inner layer 225 and an outer layer 226. In the second modification example, the inner layer 225 is formed of the same composition as the adhesive polyethylene composition that forms the adhesive polyethylene layer 26 of the first embodiment. In addition, in the second modification example, the outer layer 226 is formed of the same composition as the conductive polyamide resin composition that forms the conductive polyamide layer 25 of the first embodiment. Therefore, in the second modification example, the fuel vapor pipe 220a has conductivity on the outer layer 226.

The fuel vapor port 23b includes a conductive outer layer contact portion 239. Similar to the conductive outer layer contact portion 29 of the second embodiment, the conductive outer layer contact portion 239 is formed by an injection forming to be integrated with the conductive polyamide layer 25a. In addition, the conductive outer layer contact portion 239 is provided to protrude in the outer diameter direction from the conductive polyamide layer 25a having a substantially pipe shape, and to penetrate the adhesive polyethylene layer 26a. Therefore, similar to the conductive outer layer contact portion 29 of the second embodiment, the conductive outer layer contact portion 239 has conductivity. Similar to the conductive outer layer contact portion 29, two conductive outer layer contact portions 239 having a claw-shaped external appearance shape are provided at two locations at positions symmetric to each other at the outer circumference of the fuel vapor port 23b. The filler neck 20c and the conductive outer layer contact portion 239 are connected to each other such that the conductive outer layer contact portion 239 is bitten into the outer layer 226 of the fuel vapor pipe 220a. In addition, in the second modification example, the valve device BV is formed of the same composition as the conductive polyamide resin composition that forms the conductive polyamide layer 25 of the first embodiment.

In the fuel feed apparatus including the filler neck 20c having the above-mentioned configuration, the earth path which extends to the fuel tank FT through the fuel vapor pipe 220a and the valve device BV from the inner side of the filler neck 20c, is formed. In the configuration in which the fuel tank FT is attached to the vehicle main body BD by the attaching fitting or the like which is not illustrated, the earth path to the vehicle main body BD from the fuel tank FT exists. Therefore, for example, in the case where the nozzle NZ is inserted into the inner flow path 11a for feeding fuel, and the nozzle NZ comes into contact with the conductive polyamide layer 25a of the filler neck 20c, with the nozzle NZ as a starting point, the earth path which reaches the vehicle main body BD through the conductive polyamide layer 25a of the filler neck 20a, the conductive outer layer contact portion 239, the outer layer 226 of the fuel vapor pipe 220a, the valve device BV, the fuel tank FT, and the attaching fitting which is not illustrated, is formed, and the electricity charged to the nozzle NZ is discharged through the earth path.

The filler neck 20c of the second modification example of the second embodiment having the above-described configuration has an effect similar to that of the filler neck 20a of the second embodiment. Here, in the second modification example of the second embodiment, the filler neck 20c, the fuel vapor pipe 220a, the valve device BV, and the fuel tank tube connection device 110a correspond to a subordinate concept of the component for a fuel feed apparatus as mentioned in the summary of the present invention.

### D. Modification Example

### D1. Modification Example 1

In the above-described embodiments, as application examples of the component for a fuel feed apparatus of the present invention, the filler necks 20, 20a, 20b, and 20c, the fuel pipe 210a, the fuel tank tube connection device 110a, the fuel vapor pipe 220a, and the valve device BV are illustrated, but the present invention is not limited to the components. For example, the component for a fuel feed apparatus of the present invention may be employed for the valve device BV, the fuel tank FT, and the fuel cap FC. In addition, for example, the component for a fuel feed apparatus of the present invention may be employed with respect to the configuration component that configures each of the components described in each of the embodiments, such as the bracket 70 or the like which is used in the filler neck 20. In addition, for example, in the case where the fuel pipe 210 or the fuel vapor pipe 220 has a structure in which a plurality of pipe members are connected to each other by a connection member, the component for a fuel feed apparatus of the present invention may be employed in the connection member. In addition, for example, in the configuration in which the fuel tank FT is connected to a canister via a pipe, the component for a fuel feed apparatus of the present invention may be employed in the pipe or the valve device provided at the connection part between the pipe and the fuel tank FT. Examples of the valve device include a filled-up state regulating valve device which has a function of switching execution and stop of the feeding of the fuel vapor to the canister, and a function of stopping the feeding of fuel by making a sensor in the nozzle NZ detect when a filled-up state is achieved during feeding the fuel. In other words, in general, the component for a fuel feed apparatus of the present invention may be employed in an arbitrary component used in the fuel feed apparatus that feeds the fuel to the fuel tank FT.

### D2. Modification Example 2

In the above-described embodiments, the layer formed of the conductive polyamide resin composition, for example, the conductive polyamide layer 25 is used to form the two-layered structure together with the adhesive polyethylene layer. However, the layer formed of the conductive polyamide resin composition may be used to form a structure having three or more layers together with a layer formed of another resin composition, or may be used as a single layer.

### D3. Modification Example 3

In the above-described embodiments, the conductive polyamide resin composition satisfies the characteristic (c), that is, “a melt index measured at a temperature of 250° C. and a load of 10 kgf is 2 g/10 min or greater”, but this characteristic (c) may not be satisfied. In addition, in the above-described embodiments, polyethylene of the conductive polyethylene resin (D) contained in the conductive polyamide resin composition is high-density polyethylene, but may be another type of polyethylene.

The present invention is not limited to the above-described embodiments, Examples, and Modification Examples, and can be realized by various configurations within a range that does not depart from the spirit of the present invention. For example, technical characteristics in the embodiments, Examples, and Modification Examples which correspond to the technical characteristics in each of the aspects described in the summary of the present invention, can be appropriately switched or combined to each other in order to solve a part or the entirety of the above-described problems or in order to achieve a part or the entirety of the above-described effects. In addition, a technical characteristic that is not disclosed as a necessary characteristic in the specification, can be appropriately removed.

The present application is based on Japanese patent application No. 2017-020064 filed on Feb. 7, 2017, which contents are incorporated herein by reference.

### DESCRIPTION OF REFERENCE NUMERALS AND SIGNS

BD Vehicle main body
BV Valve device
CX, CX2 Axial line
D1, D2, D3 Feeding direction
ER Earth path
FC Fuel cap
FT Fuel tank
FTa Opening
IOP Inner opening
NZ Nozzle
OP Opening
R1, R2 Direction
T1 Fuel cap contact portion
11, 11a Inner flow path
20, 20a, 20b, 20c Filler neck
20s Screw thread
21, 21a Neck main body
22, 22a Neck connection portion
23, 23a, 23b Fuel vapor port
23P, 23Pa Fuel vapor passage
24 Opening portion
25, 25a, 25b Conductive polyamide layer
26, 26a, 26b Adhesive polyethylene layer
28 Screw thread
29, 29a Conductive outer layer contact portion
30 First opening forming member
30s Screw thread
32 Cover member
32a Side wall portion
32b Upper wall
32d Opening portion
32f Shaft support portion
34 Opening side wall member
34a Inclined wall
38 Regulating portion
50 First valve device
51 Valve body
52 Spring
60 Second valve device
61 Valve body
61a Pressing member
61b Valve chamber forming member
62 Bearing portion
63 Spring
64 Gasket
65 Pressure regulating valve
66 Second opening forming member
70 Bracket
80 Seal member
110, 110a Fuel tank tube connection device
112 Inner layer
112a Passage portion
112b Locking expansion portion
112c First flange
113a Pipe portion
113b Flange portion
114 Outer layer
114a Outer pipe portion
114b Second flange portion
114c First welding portion
114d Second welding portion
114e Outer layer contact portion
120 Check valve
122 Passage forming member
125 End portion
126 Attaching portion
127 Valve plate
128 Regulating member
129 Feeding port
210, 210a Fuel pipe
215 Inner layer
216 Outer layer
220, 220a Fuel vapor pipe
225 Inner layer
226 Outer layer
239 Conductive outer layer contact portion
500 Fuel feed apparatus
510 Fuel flow path
600 Fixing member

What is claimed is:

1. A component used in a fuel feed apparatus (500) that feeds fuel to a fuel tank (FT), the component comprising:
a conductive polyamide layer (25) that is configured to be in contact with fuel or fuel vapor in a use state, and is formed of a conductive polyamide resin composition,
wherein the conductive polyamide resin composition comprises:
(A) 84 to 40% by weight of a polyamide resin,
(B) 5 to 30% by weight of a conductive carbon black,
(C) 3 to 30% by weight of an ethylene-α-olefin copolymer having a reactive functional group capable of reacting with a terminal group and/or an amide group in a main chain of the polyamide resin, and
(D) 1 to 20% by weight of a conductive polyethylene resin, and
wherein the conductive polyamide resin composition satisfies the following characteristics (a) and (b):
(a) initial volume resistivity of a flat plate (100 mm×100 mm×2 mm (thickness)) obtained by injection forming the conductive polyamide resin composition is 1×10⁵ Ω·cm or less, and volume resistivity after exposing the flat plate to CM15 fuel for 168 hours is 1×10⁷ Ω·cm or less, and
(b) charpy impact strength at −40° C. of a test piece obtained by injection forming the conductive polyamide resin composition is 2.0 KJ/m² or greater.

2. The component according to claim 1,
wherein the conductive polyamide resin composition further satisfies the following characteristic (c):
(c) a melt index measured at a temperature of 250° C. and at a load of 10 kgf is 2 g/10 min or greater.

3. The component according to claim 1,
wherein the conductive polyethylene resin (D) comprises a high-density polyethylene.

4. The component according to claim 1, further comprising:
an adhesive polyethylene layer (26) that is configured to be in contact with an outer surface of the conductive polyamide layer.

5. The component according to claim 1, which forms at least a part of a fuel flow path (510) which guides the fuel fed from an oil feed gun to the fuel tank (FT).

6. The component according to claim 5,
wherein the fuel feed apparatus (500) comprises:
an opening forming member (30) that forms an opening (OP) into which the oil feed gun is inserted,
a first valve device (50) that opens and closes the opening (OP),
a second valve device (60) that is positioned further on the fuel tank (FT) side than the first valve device (50), and is opened by insertion of the oil feed gun and closed by extraction of the oil feed gun, and
a hollow filler neck (20) that forms a part of the fuel flow path (510), is connected to the opening forming member (30) on the fuel tank (FT) side, and accommodates the second valve device (60) on an inner side thereof, and
wherein the component is configured as the filler neck (20).
